(19) United States
(12) Patent Application Publication
(10) Pub. No.: US 2019/0325607 A1
(43) Pub. Date: Oct. 24, 2019

(54) MOVEMENT INFORMATION ESTIMATION DEVICE, ABNORMALITY DETECTION DEVICE, AND ABNORMALITY DETECTION METHOD

(71) Applicant: DENSO TEN Limited, Kobe-shi (JP)

(72) Inventors: Kohji OHNISHI, Kobe-shi (JP); Naoshi KAKITA, Kobe-shi (JP); Takayuki OZASA, Kobe-shi (JP); Takeo MATSUMOTO, Kobe-shi (JP); Teruhiko KAMIBAYASHI, Kobe-shi (JP)

(73) Assignee: DENSO TEN Limited, Kobe-shi (JP)

(21) Appl. No.: 16/270,041

(22) Filed: Feb. 7, 2019

(30) Foreign Application Priority Data
Apr. 23, 2018 (JP) 2018-082275

(51) Int. Cl. G06T 7/80; G06T 7/246; B60R 11/04; B60R 1/12

(52) U.S. Cl. CPC G06T 7/80; G06T 7/248; B60R 2001/1253; B60R 1/12; G06T 2207/30252; B60R 11/04

(57) ABSTRACT

A movement information estimation device estimates movement information on a mobile body based on information from a camera mounted on the mobile body. The movement information estimation device includes a feature point extractor configured to extract a feature point from a predetermined region in an image taken by the camera, and a movement information estimator configured to estimate movement information on the mobile body based on the feature point. If such a feature point as fulfills a particular condition is present, a particular extraction region is set instead of the predetermined region, and estimation of the movement information on the mobile body is performed based on the feature point extracted from the particular extraction region

### CROSS-REFERENCES TO RELATED APPLICATIONS

This application is based upon and claims the benefit of priority from the corresponding Japanese Patent Application No. 2018-082275 filed on Apr. 23, 2018, the entire contents of which are hereby incorporated by reference.

### BACKGROUND OF THE INVENTION

### 1. Field of the Invention

The present invention relates to abnormality detection devices and abnormality detection methods, and specifically relates to detection of abnormalities in cameras mounted on mobile bodies. The present invention also relates to estimation of movement information by use of a camera mounted on a mobile body.

### 2. Description of Related Art

Conventionally, cameras are mounted on mobile bodies such as vehicles, and such cameras are used, for example, to achieve parking assistance, etc. for vehicles. For example, a vehicle-mounted camera is fitted to a vehicle in a state fixed to it before the shipment of the vehicle from the factory. However, due to, for example, inadvertent contact, secular change, etc., a vehicle-mounted camera can develop an abnormality in the form of a misalignment from the installed state at the time of factory shipment. A deviation in the installation position and the installation angle of a vehicle-mounted camera can cause an error in the amount of steering and the like determined by use of a camera image, and thus it is important to detect an installation misalignment of the vehicle-mounted camera.

JP-A-2004-338637 discloses a vehicle travel assistance device that includes a first movement-amount calculation means which calculates the amount of movement of a vehicle, regardless of a vehicle state amount, by subjecting an image obtained by a rear camera to image processing performed by an image processor and a second movement-amount calculation means which calculates the amount of movement of the vehicle based on the vehicle state amount on the basis of the outputs of a wheel speed sensor and a steering angle sensor. For example, the first movement-amount calculation means extracts a feature point from image data obtained by the rear camera by means of edge extraction, for example, then calculates the position of the feature point on the ground surface set by means of inverse projective transformation, and calculates the amount of movement of the vehicle based on the amount of movement of the position. JP-A-2004-338637 discloses that when, as a result of comparison between the amounts of movement calculated by the first and second movement-amount calculation means, if a large deviation is found between the amounts of movement of the vehicle, then it is likely that a problem has occurred in either one of the first and second movement-amount calculation means.

### SUMMARY OF THE INVENTION

With the configuration disclosed in JP-A-2004-338637, if, for example, the number of feature points extracted is reduced, the reduction can undesirably degrade the reliability of the movement amount of the vehicle calculated by the first movement-amount calculation means. With this in mind, when a poorly reliable movement amount is obtained, comparison between the results of calculations by the first and second movement-amount calculation means may be avoided. However, with such a configuration, quick detection of abnormalities is impossible.

An object of the present invention is to provide a technology that permits proper detection of abnormalities in a camera mounted on a mobile body.

An abnormality detection device illustrative of the present invention is one that detects an abnormality in a camera mounted on a mobile body, and includes a feature point extractor configured to extract a feature point from a predetermined region in an image taken by the camera, a movement information estimator configured to estimate first movement information on the mobile body based on the feature point, a movement information acquirer configured to acquire second movement information on the mobile body, the second movement information being a target of comparison with the first movement information, and an abnormality determiner configured to determine an abnormality in the camera based on the first movement information and the second movement information. Here, if such a feature point as fulfills a particular condition is present, a particular extraction region is set instead of the predetermined region, and estimation of the first movement information is performed based on the feature point extracted from the particular extraction region.

A movement information estimation device illustrative of the present invention is one that estimates movement information on a mobile body based on information from a camera mounted on the mobile body, and includes a feature point extractor configured to extract a feature point from a predetermined region in an image taken by the camera, and a movement information estimator configured to estimate movement information on the mobile body based on the feature point. Here, if such a feature point as fulfills a particular condition is present, a particular extraction region is set instead of the predetermined region, and estimation of the movement information on the mobile body is performed based on the feature point extracted from the particular extraction region.

### BRIEF DESCRIPTION OF THE DRAWINGS

FIG. 1 is a block diagram showing a configuration of an abnormality detection system.

FIG. 2 is a diagram illustrating positions at which vehicle-mounted cameras are disposed in a vehicle.

FIG. 3 is a flow chart showing an example of a procedure for the detection of a camera misalignment performed by an abnormality detection device.

FIG. 4 is a diagram for illustrating a method for extracting feature points.

FIG. 5 is a diagram for illustrating a method for deriving a first optical flow.

FIG. 6 is a diagram for illustrating coordinate conversion processing.

FIG. 7 is a diagram showing an example of a first histogram generated by a movement information estimator.

FIG. 8 is a diagram showing an example of a second histogram generated by a movement information estimator.

FIG. 9 is a diagram illustrating a change caused in a histogram by a camera misalignment.

FIG. 10 is a flow chart showing an example of camera misalignment determination processing performed by an abnormality determiner.

FIG. 11 is a flow chart showing a procedure for determining whether or not to perform exceptional processing.

FIG. 12 is a diagram for illustrating the degree of variations in optical flows.

FIG. 13 is a flow chart showing a procedure for exceptional processing.

FIG. 14 is a diagram showing an example of a taken image taken by a camera.

FIG. 15 is a first histogram generated based on the taken image shown in FIG. 14.

FIG. 16 is a diagram for illustrating a particular extraction region.

FIG. 17 is a diagram for illustrating cornerness degree.

### DETAILED DESCRIPTION OF PREFERRED EMBODIMENTS

Hereinafter, illustrative embodiments of the present invention will be described in detail with reference to the accompanying drawings. Although the following description deals with a vehicle as an example of a mobile body, this is not meant as any limitation to vehicles; any mobile bodies are within the scope. Vehicles include a wide variety of wheeled vehicle types, including automobiles, trains, automated guided vehicles, etc. Mobile bodies other than vehicles include, for example, ships, airplanes, etc.

The different directions mentioned in the following description are defined as follows. The direction which runs along the vehicle's straight traveling direction and which points from the driver's seat to the steering wheel is referred to as the “front” direction. The direction which runs along the vehicle's straight traveling direction and which points from the steering wheel to the driver's seat is referred to as the “rear” direction. The direction which runs perpendicularly to both the vehicle's straight traveling direction and the vertical line and which points from the right side to the left side of the driver facing frontward is referred to as the “left” direction. The direction which runs perpendicularly to both the vehicle's straight traveling direction and the vertical line and which points from the left side to the right side of the driver facing frontward is referred to as the “right” direction.

<1. Abnormality Detection System>

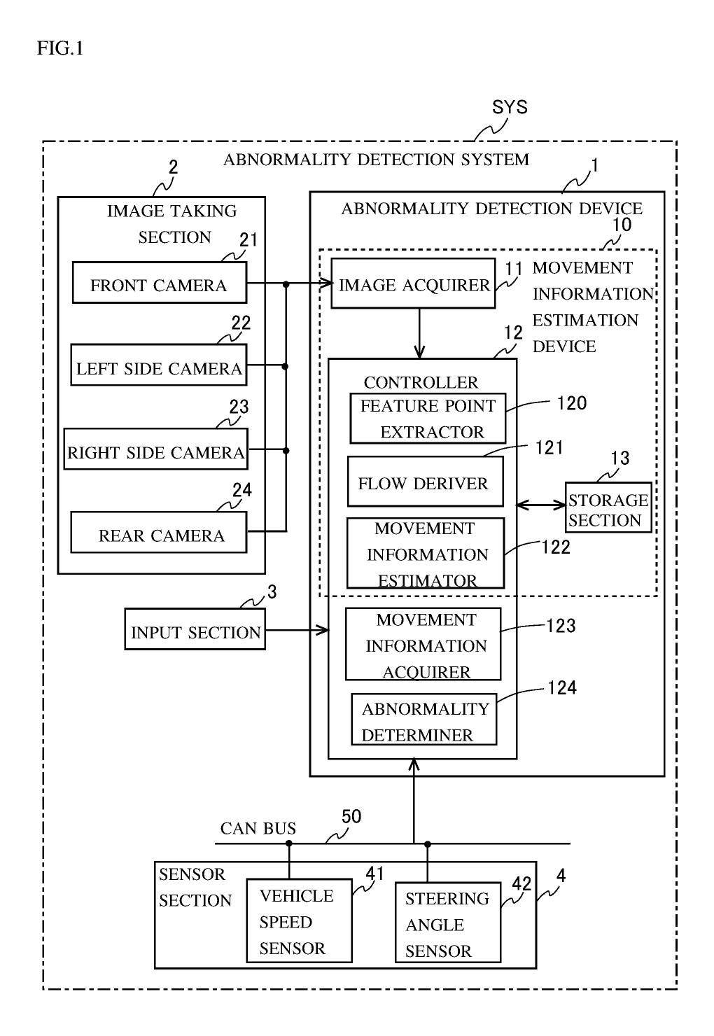

FIG. 1 is a block diagram showing a configuration of an abnormality detection system SYS according to an embodiment of the present invention. In this embodiment, an abnormality is defined as a state where a misalignment has developed in the installation of a camera. That is, the abnormality detection system SYS is a system that detects a misalignment in how a camera mounted on a vehicle is installed. More specifically, the abnormality detection system SYS is a system for detecting an abnormality such as a misalignment of a camera mounted on a vehicle from its reference installed state such as its installed state at the time of factory shipment of the vehicle. As shown in FIG. 1, the abnormality detection system SYS includes an abnormality detection device 1, an image taking section 2, an input section 3, and a sensor section 4.

The abnormality detection device 1 is a device for detecting abnormalities in a camera mounted on a vehicle. More specifically, the abnormality detection device 1 is a device for detecting an installation misalignment in how the cameras are installed on the vehicle. The installation misalignment includes deviations in the installation position and the installation angle of the cameras. By using the abnormality detection device 1, it is possible to promptly detect a misalignment in how the cameras mounted on the vehicle are installed, and thus to prevent driving assistance and the like from being performed with a camera misalignment. Hereinafter, a camera mounted on a vehicle may be referred to as “vehicle-mounted camera”. Here, as shown in FIG. 1, the abnormality detection device 1 includes a movement information estimation device 10 which estimates movement information on a vehicle based on information from cameras mounted on the vehicle.

The abnormality detection device 1 is provided on each vehicle furnished with vehicle-mounted cameras. The abnormality detection device 1 processes images taken by vehicle-mounted cameras 21 to 24 included in the image taking section 2 as well as information from the sensor section 4 provided outside the abnormality detection device 1, and thereby detects deviations in the installation position and the installation angle of the vehicle-mounted cameras 21 to 24. The abnormality detection device 1 will be described in detail later.

Here, the abnormality detection device 1 may output the processed information to a display device, a driving assisting device, or the like, of which none is illustrated. The display device may display, on a screen, warnings and the like, as necessary, based on the information fed from the abnormality detection device 1. The driving assisting device may halt a driving assisting function, or correct taken-image information to perform driving assistance, as necessary, based on the information fed from the abnormality detection device 1. The driving assisting device may be, for example, a device that assists automatic driving, a device that assists automatic parking, a device that assists emergency braking, etc.

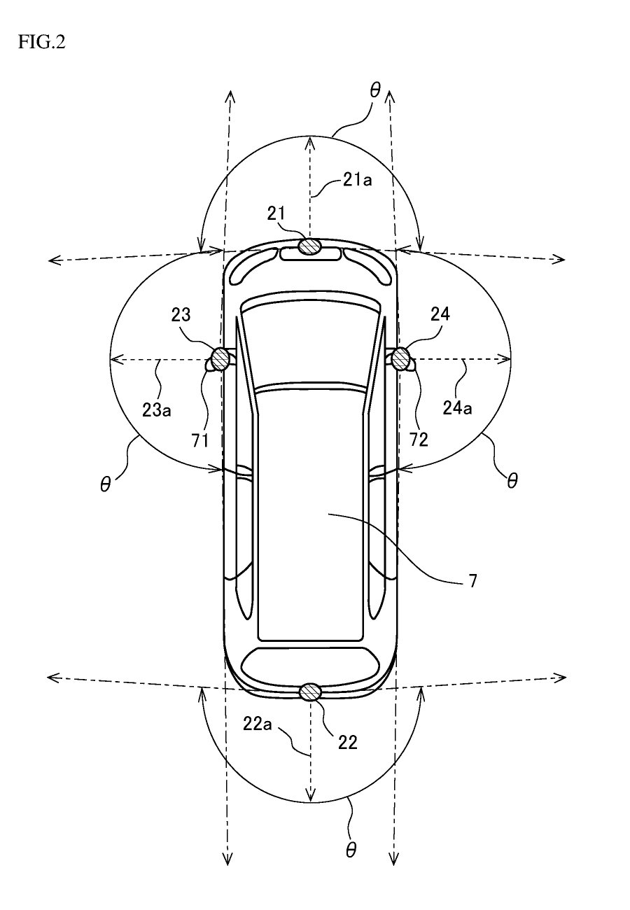

The image taking section 2 is provided on the vehicle for the purpose of monitoring the circumstances around the vehicle. In this embodiment, the image taking section 2 includes four vehicle-mounted cameras 21 to 24. The vehicle-mounted cameras 21 to 24 are each connected to the abnormality detection device 1 on a wired or wireless basis. FIG. 2 is a diagram showing an example of the positions at which the vehicle-mounted cameras 21 to 24 are disposed on a vehicle 7. FIG. 2 is a view of the vehicle 7 as seen from above. The vehicle illustrated in FIG. 2 is an automobile.

The vehicle-mounted camera 21 is provided at the front end of the vehicle 7. Accordingly, the vehicle-mounted camera 21 is referred to also as a front camera 21. The optical axis 21a of the front camera 21 runs along the front-rear direction of the vehicle 7. The front camera 21 takes an image frontward of the vehicle 7. The vehicle-mounted camera 22 is provided at the rear end of the vehicle 7. Accordingly, the vehicle-mounted camera 22 is referred to also as a rear camera 22. The optical axis 22a of the rear camera 22 runs along the front-rear direction of the vehicle 7. The rear camera 22 takes an image rearward of the vehicle 7. The installation positions of the front and rear cameras 21 and 22 are preferably at the center in the left-right direction of the vehicle 7, but may instead be positions slightly deviated from the center in the left-right direction.

The vehicle-mounted camera 23 is provided on a left-side door mirror 71 of the vehicle 7. Accordingly, the vehicle-mounted camera 23 is referred to also as a left side camera 23. The optical axis 23a of the left side camera 23 runs along the left-right direction of the vehicle 7. The left side camera 23 takes an image leftward of the vehicle 7. The vehicle-mounted camera 24 is provided on a right-side door mirror 72 of the vehicle 7. Accordingly, the vehicle-mounted camera 24 is referred to also as a right side camera 24. The optical axis 24a of the right side camera 24 runs along the left-right direction of the vehicle 7. The right side camera 24 takes an image rightward of the vehicle 7.

The vehicle-mounted cameras 21 to 24 all have fish-eye lenses with an angle of view of 180° or more in the horizontal direction. Thus, the vehicle-mounted cameras 21 to 24 can together take an image all around the vehicle 7 in the horizontal direction. Although, in this embodiment, the number of vehicle-mounted cameras is four, the number may be changed as necessary; there may be provided a plurality of vehicle-mounted cameras or a single vehicle-mounted camera. For example, in a case where the vehicle 7 is furnished with a vehicle-mounted camera for the purpose of assisting reverse parking of the vehicle 7, the image taking section 2 may include three vehicle-mounted cameras, namely the rear camera 22, the left side camera 23, and the right side camera 24.

With reference back to FIG. 1, the input section 3 is configured to accept instructions to the abnormality detection device 1. The input section 3 may include, for example, a touch screen, buttons, levers, etc. The input section 3 is connected to the abnormality detection device 1 on a wired or wireless basis.

The sensor section 4 includes a plurality of sensors that detect information on the vehicle 7 furnished with the vehicle-mounted cameras 21 to 24. In this embodiment, the sensor section 4 includes a vehicle speed sensor 41 and a steering angle sensor 42. The vehicle speed sensor 41 detects the speed of the vehicle 7. The steering angle sensor 42 detects the rotation angle of the steering wheel of the vehicle 7. The vehicle speed sensor 41 and the steering angle sensor 42 are connected to the abnormality detection device 1 via a communication bus 50. That is, the information on the speed of the vehicle 7 acquired by the vehicle speed sensor 41 is fed to the abnormality detection device 1 via the communication bus 50. The information on the rotation angle of the steering wheel of the vehicle 7 acquired by the steering angle sensor 42 is fed to the abnormality detection device 1 via the communication bus 50. The communication bus 50 may be, for example, a CAN (controller area network) bus.

<2. Abnormality Detection Device>

<2-1. Outline of Abnormality Detection Device>

As shown in FIG. 1, the abnormality detection device 1 includes an image acquirer 11, a controller 12, and a storage section 13.

The image acquirer 11 acquires images from each of the four vehicle-mounted cameras 21 to 24. The image acquirer 11 has basic image processing functions such as an analog-to-digital conversion function for converting analog taken images into digital taken images. The image acquirer 11 subjects the acquired taken images to predetermined image processing, and feeds the processed taken images to the controller 12.

The controller 12 is, for example, a microcomputer, and controls the entire abnormality detection device 1 in a concentrated fashion. The controller 12 includes a CPU, a RAM, a ROM, etc. The storage section 13 is, for example, a non-volatile memory such as a flash memory, and stores various kinds of information. The storage section 13 stores programs as firmware and various kinds of data.

More specifically, the controller 12 includes a feature point extractor 120, a flow deriver 121, a movement information estimator 122, a movement information acquirer 123, and an abnormality determiner 124. That is, the abnormality detection device 1 includes the feature point extractor 120, the deriver 121, the movement information estimator 122, the movement information acquirer 123, and the abnormality determiner 124. The functions of these portions 120 to 124 provided in the controller 12 are achieved, for example, through operational processing performed by the CPU according to the programs stored in the storage section 13.

At least one of the feature point extractor 120, the flow deriver 121, the movement information estimator 122, the movement information acquirer 123, and the abnormality determiner 124 in the controller 12 may be configured in hardware such as an ASIC (application-specific integrated circuit) or an FPGA (field-programmable gate array). The feature point extractor 120, the flow deriver 121, the movement information estimator 122, the movement information acquirer 123, and the abnormality determiner 124 are conceptual constituent elements; the functions carried out by any one of them may be distributed among a plurality of constituent elements, or the functions of a plurality of constituent elements may be integrated into a single constituent element. The image acquirer 11 may be achieved by the CPU in the controller 12 performing calculation processing according to a program.

The feature point extractor 120 extracts feature points from a predetermined region in an image taken by a camera. In this embodiment, the vehicle 7 has the four vehicle-mounted cameras 21 to 24. With this configuration, the feature point extractor 120 performs feature-point extraction processing on images from the vehicle-mounted cameras 21 to 24. A feature point is an outstandingly detectable point in a taken image, such as an intersection between edges in a taken image. A feature point is, for example, an edge of a white line drawn on the road surface, a crack in the road surface, a speck on the road surface, a piece of gravel on the road surface, etc. Usually, there are a number of feature points in one taken image. The feature point extractor 120 extracts feature points by means of a well-known method such as the Harris operator.

The flow deriver 121 derives an optical flow for each feature point extracted by the feature point extractor 120. An optical flow is a motion vector representing the movement of a feature point between two images taken at a predetermined time interval from each other. In this embodiment, optical flows derived by the flow deriver 121 include first optical flows and second optical flows. First optical flows are optical flows acquired from images (images themselves) taken by the cameras 21 to 24. Second optical flows are optical flows acquired by subjecting the first optical flows to coordinate conversion. Herein, such a first optical flow OF1 and a second optical flow OF2 as are derived from the same feature point will sometimes be referred to simply as an optical flow when there is no need of making a distinction between them.

In this embodiment, the vehicle 7 is furnished with the four vehicle-mounted cameras 21 to 24. Accordingly, the flow deriver 121 derives an optical flow for each feature point for each of the vehicle-mounted cameras 21 to 24. The flow deriver 121 may be configured to directly derive optical flows corresponding to the second optical flows mentioned above by subjecting, to coordinate conversion, the feature points extracted from images taken by the cameras 21 to 24. In this case, the flow deriver 121 does not derive the first optical flows described above, but derives only one kind of optical flows.

The movement information estimator 122 estimates first movement information on the vehicle 7 based on feature points. Specifically, the movement information estimator 122 estimates the first movement information on the vehicle 7 based on optical flows of feature points. In this embodiment, the movement information estimator 122 performs statistical processing on a plurality of second optical flows to estimate the first movement information. In this embodiment, since the vehicle 7 is furnished with the four vehicle-mounted cameras 21 to 24, the movement information estimator 122 estimates the first movement information on the vehicle 7 for each of the vehicle-mounted cameras 21 to 24. The statistical processing performed by the movement information estimator 122 is processing performed by using histograms. Details will be given later of the histogram-based processing for estimating the first movement information.

In this embodiment, the first movement information is information on the movement distance of the vehicle 7. The first movement information may be, however, information on a factor other than the movement distance. The first movement information may be information on, for example, the speed (vehicle speed) of the vehicle 7.

The movement information acquirer 123 acquires second movement information on the vehicle 7 as a target of comparison with the first movement information. In this embodiment, the movement information acquirer 123 acquires the second movement information based on information obtained from a sensor other than the cameras 21 to 24 provided on the vehicle 7. More specifically, the movement information acquirer 123 acquires the second movement information based on information obtained from the sensor section 4. In this embodiment, since the first movement information is information on the movement distance, the second movement information, which is to be the target of comparison with the first movement information, is also information on the movement distance. The movement information acquirer 123 acquires the movement distance by multiplying the vehicle speed obtained from the vehicle speed sensor 41 by a predetermined time. According to this embodiment, it is possible to detect a camera misalignment by using a sensor generally provided on the vehicle 7, and this helps reduce the cost of equipment required to achieve camera misalignment detection.

In a case where the first movement information is information on the vehicle speed instead of the movement distance, the second movement information is also information on the vehicle speed. The movement information acquirer 123 may acquire the second movement information based on information acquired from a GPS (Global Positioning System) receiver, instead of from the vehicle speed sensor 41. The movement information acquirer 123 may be configured to acquire the second movement information based on information obtained from at least one of the vehicle-mounted cameras excluding one that is to be the target of camera-misalignment detection. In this case, the movement information acquirer 123 may acquire the second movement information based on optical flows obtained from the vehicle-mounted cameras other than the one that is to be the target of camera-misalignment detection.

The abnormality determiner 124 determines abnormalities in the cameras 21 to 24 based on the first movement information and the second movement information. In this embodiment, the abnormality determiner 124 uses the movement distance, obtained as the second movement information, as a correct value, and determines the deviation, with respect to the correct value, of the movement distance obtained as the first movement information. When the deviation is above a predetermined threshold value, the abnormality determiner 124 detects a camera misalignment. In this embodiment, since the vehicle 7 is furnished with the four vehicle-mounted cameras 21 to 24, the abnormality determiner 124 performs abnormality determination for each of the vehicle-mounted cameras 21 to 24.

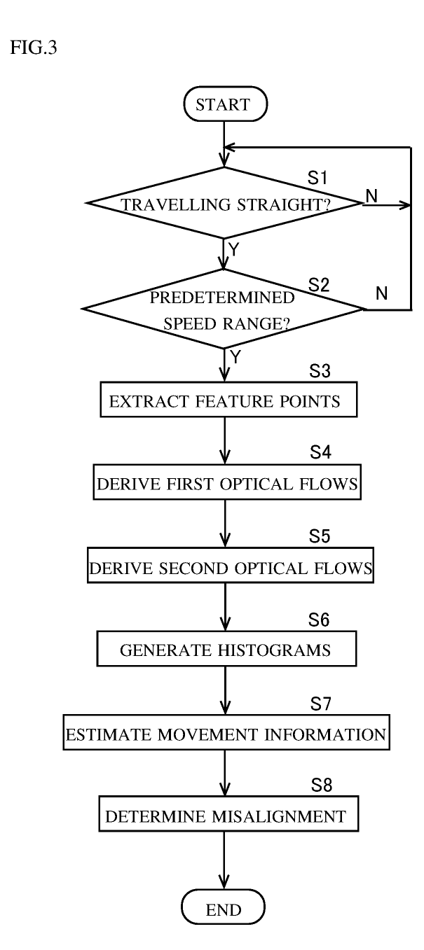

FIG. 3 is a flow chart showing an example of a procedure for the detection of a camera misalignment performed by the abnormality detection device 1. In this embodiment, the camera misalignment detection procedure shown in FIG. 3 is performed for each of the four vehicle-mounted cameras 21 to 24. Here, to avoid overlapping description, the camera misalignment detection procedure will be described with respect to the front camera 21 as a representative.

As shown in FIG. 3, first, the controller 12 monitors whether or not the vehicle 7, which is furnished with the front camera 21, is traveling straight (step S1). Whether or not the vehicle 7 is traveling straight can be judged, for example, based on the rotation angle information on the steering wheel, which is obtained from the steering angle sensor 42. For example, assuming that the vehicle 7 travels completely straight when the rotation angle of the steering wheel equals zero, then, not only when the rotation angle equals zero but also when it falls within a certain range in the positive and negative directions, the vehicle 7 may be judged to be traveling straight. Straight traveling includes both forward straight traveling and backward straight traveling.

The controller 12 repeats the monitoring in step S1 until straight traveling of the vehicle 7 is detected. Unless the vehicle 7 travels straight, no information for determining a camera misalignment is acquired. With this configuration, no determination of a camera misalignment is performed by use of information acquired when the vehicle 7 is traveling along a curved path; this helps avoid complicating the information processing for the determination of a camera misalignment.

If the vehicle 7 is judged to be traveling straight (Yes in step S1), the controller 12 checks whether or not the speed of the vehicle 7 is within a predetermined speed range (step S2). The predetermined speed range may be, for example, 3 km per hour or higher but 5 km per hour or lower. In this embodiment, the speed of the vehicle 7 can be acquired by means of the vehicle speed sensor 41. Steps S1 and S2 may be reversed in order. Steps S1 and S2 may be performed concurrently.

If the speed of the vehicle 7 is outside the predetermined speed range (No in step S2), then, back in step S1, the controller 12 makes a judgment on whether or not the vehicle 7 is traveling straight. That is, in this embodiment, unless the speed of the vehicle 7 is within the predetermined speed range, no information for determining a camera misalignment is acquired. For example, if the speed of the vehicle 7 is too high, errors are apt to occur in the derivation of optical flows. On the other hand, if the speed of the vehicle 7 is too low, the reliability of the speed of the vehicle 7 acquired from the vehicle speed sensor 41 deteriorates. In this respect, with the configuration according to this embodiment, a camera misalignment is determined except when the speed of the vehicle 7 is too high or too low, and this helps enhance the reliability of camera misalignment determination.

It is preferable that the predetermined speed range be variably set. With this configuration, the predetermined speed range can be adapted to cover values that suit individual vehicles, and this helps enhance the reliability of camera misalignment determination. In this embodiment, the predetermined speed range can be set via the input section 3.

When the vehicle 7 is judged to be traveling within the predetermined speed range (Yes in step S2), the feature point extractor 120 extracts a feature point (step S3). It is preferable that the extraction of a feature point by the feature point extractor 120 be performed when the vehicle 7 is traveling stably within the predetermined speed range.

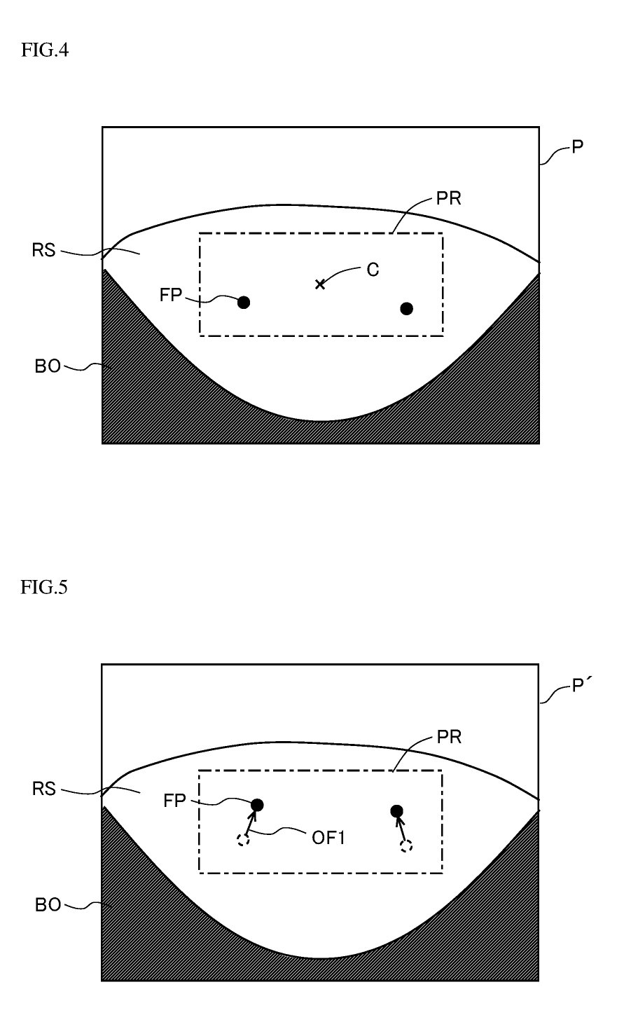

FIG. 4 is a diagram for illustrating a method for extracting feature points FP. FIG. 4 schematically shows a taken image P that is taken by the front camera 21. The feature points FP exist on the road surface RS. In FIG. 4, two feature points FP are shown, but the number here is set merely for convenience of description, and does not indicate the number of actually extracted feature points FP. Usually, a large number of feature points FP are acquired.

As shown in FIG. 4, the feature point extractor 120 extracts feature points FP from a predetermined region PR in the taken image P taken by the front camera 21. The predetermined region PR is what is called ROI (Region of Interest). In this embodiment, the ROI is set to be a wide range including the center C of the taken image P. This makes it possible to extract feature points FP even in cases where they appear at unevenly distributed spots, in a lopsided range. The ROI is set excluding a region where a body BO of the vehicle 7 shows.

When feature points FP are extracted, the flow deriver 121 derives a first optical flow for each of the extracted feature points FP (step S4). FIG. 5 is a diagram for illustrating a method for deriving a first optical flow OF1. FIG. 5, like FIG. 4, is a schematic diagram illustrated for convenience of description. What FIG. 5 shows is the taken image (current frame P′) that is taken by the front camera 21 a predetermined period after the taking of the taken image (previous frame P) shown in FIG. 4. After the taking of the taken image P shown in FIG. 4, by the time that the predetermined period expires, the vehicle 7 has reversed. The broken-line circles in FIG. 5 indicate the positions of the feature points FP at the time of the taking of the taken image P shown in FIG. 4.

As shown in FIG. 5, as the vehicle 7 reverses, the feature points FP located ahead of the vehicle 7 move away from the vehicle 7. That is, the positions at which the feature points FP appear are different between in the current frame P′ and in the previous frame P. The flow deriver 121 associates the feature points FP in the current frame P′ with the feature points FP in the previous frame P based on pixel values nearby, and derives first optical flows OF1 based on the respective positions of the feature points FP thus associated with each other.

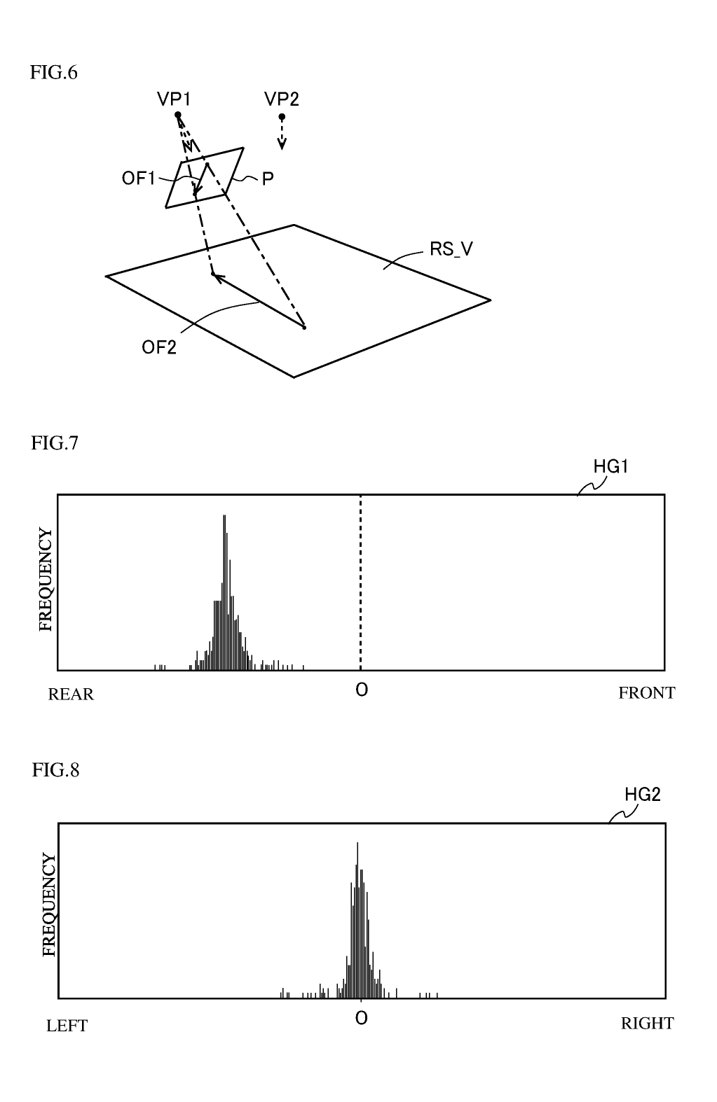

When the first optical flows OF1 are derived, the flow deriver 121 performs coordinate conversion on the first optical flows OF1, which have been obtained in the camera coordinate system, and thereby derives second optical flows OF2 in the world coordinate system (step S5). FIG. 6 is a diagram for illustrating the coordinate conversion processing. As shown in FIG. 6, the flow deriver 121 converts a first optical flow OF1 as seen from the position (view point VP1) of the front camera 21 into a second optical flow OF2 as seen from a view point VP2 above the road surface which the vehicle 7 is on. The flow deriver 121 converts each first optical flow OF1 in the taken image P into a second optical flow OF2 in the world coordinate system by projecting the former on a virtual plane RS_V that corresponds to the road surface. The second optical flow OF2 is a movement vector of the vehicle 7 on a road surface RS, and its magnitude indicates the amount of movement of the vehicle 7 on the road surface RS.

Next, the movement information estimator 122 generates a histogram based on a plurality of second optical flows OF2 derived by the flow deriver 121 (step S6). In this embodiment, the movement information estimator 122 divides each second optical flow OF2 into two, front-rear and left-right, components, and generates a first histogram and a second histogram. FIG. 7 is a diagram showing an example of the first histogram HG1 generated by the movement information estimator 122. FIG. 8 is a diagram showing an example of the second histogram HG2 generated by the movement information estimator 122. FIGS. 7 and 8 show histograms that are obtained when no camera misalignment is present.

The first histogram HG1 shown in FIG. 7 is a histogram obtained based on the front-rear component of each of the second optical flows OF2. The first histogram HG1 is a histogram where the number of second optical flows OF2 is taken along the frequency axis and the movement distance in the front-rear direction (the length of the front-rear component of each of the second optical flows OF2) is taken along the class axis. The second histogram HG2 shown in FIG. 8 is a histogram obtained based on the left-right component of each of the second optical flows OF2. The second histogram HG2 is a histogram where the number of second optical flows OF2 is taken along the frequency axis and the movement distance in the left-right direction (the length of the left-right component of each of the second optical flows OF2) is taken along the class axis.

FIGS. 7 and 8 show histograms obtained when, while no camera misalignment is present, the vehicle 7 has traveled straight backward at a speed within the predetermined speed range. Accordingly, the first histogram HG1 has a normal distribution shape in which the frequency is high lopsidedly around a particular movement distance (class) on the rear side. On the other hand, the second histogram HG2 has a normal distribution shape in which the frequency is high lopsidedly around a class near zero of the movement distance.

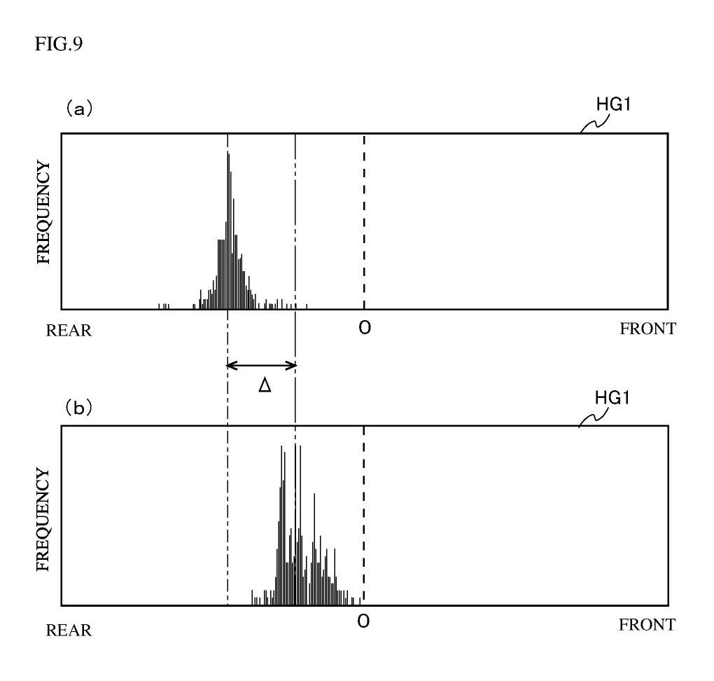

FIG. 9 is a diagram illustrating a change caused in a histogram by a camera misalignment. FIG. 9 illustrates a case where the front camera 21 is misaligned as a result of rotation in the tilt direction (vertical direction). In FIG. 9, in the upper tier (a) is the first histogram HG1 obtained with no camera misalignment present (in the normal condition), and in the lower tier (b) is the first histogram HG1 obtained with a camera misalignment present. A misalignment of the front camera 21 resulting from rotation in the tilt direction has an effect chiefly on the front-rear component of a second optical flow OF2. In the example shown in FIG. 9, the misalignment of the front camera 21 resulting form rotation in the tilt direction causes the classes where the frequency is high to be displaced frontward as compared with in the normal condition.

A misalignment of the front camera 21 resulting from rotation in the tilt direction has only a slight effect on the left-right component of a second optical flow OF2. Accordingly, though not illustrated, the change of the second histogram HG2 without and with a camera misalignment is smaller than that of the first histogram HG1. This, however, is the case when the front camera 21 is misaligned in the tilt direction; if the front camera 21 is misaligned, for example, in a pan direction (horizontal direction) or in a roll direction (the direction of rotation about the optical axis), the histograms change in a different fashion.

Based on the generated histograms HG1 and HG2, the movement information estimator 122 estimates the first movement information on the vehicle 7 (step S7). In this embodiment, the movement information estimator 122 estimates the movement distance of the vehicle 7 in the front-rear direction based on the first histogram HG1. The movement information estimator 122 estimates the movement distance of the vehicle 7 in the left-right direction based on the second histogram HG2. That is, the movement information estimator 122 estimates, as the first movement information, the movement distances of the vehicle 7 in the front-rear and left-right directions. With this configuration, it is possible to detect a camera misalignment by use of estimated values of the movement distances of the vehicle 7 in the front-rear and left-right directions, and it is thus possible to enhance the reliability of the result of camera misalignment detection.

In this embodiment, the movement information estimator 122 takes the middle value (median) of the first histogram HG1 as the estimated value of the movement distance in the front-rear direction. The movement information estimator 122 takes the middle value of the second histogram HG2 as the estimated value of the movement distance in the left-rear direction. This, however, is not meant to limit the method by which the movement information estimator 122 determines the estimated values. For example, the movement information estimator 122 may take the movement distances of the classes where the frequencies in the histograms HG1 and HG2 are respectively maximum as the estimated values of the movement distances. For another example, the movement information estimator 122 may take the average values in the respective histograms HG1 and HG2 as the estimated values of the movement distances.

In the example shown in FIG. 9, a dash-dot line indicates the estimated value of the movement distance in the front-rear direction when the front camera 21 is in the normal condition, and a dash-dot-dot line indicates the estimated value of the movement distance in the front-rear direction when a camera misalignment is present. As shown in FIG. 9, a camera misalignment produces a difference A in the estimated value of the movement distance in the front-rear direction.

When estimated values of the first movement information on the vehicle 7 are obtained by the movement information estimator 122, the abnormality determiner 124 determines a misalignment of the front camera 21 by comparing the estimated values with second movement information acquired by the movement information acquirer 123 (step S8).

The movement information acquirer 123 acquires, as the second movement information, the movement distances of the vehicle 7 in the front-rear and left-right directions. In this embodiment, the movement information acquirer 123 acquires the movement distances of the vehicle 7 in the front-rear and left-right directions based on information obtained from the sensor section 4. There is no particular limitation to the timing with which the movement information acquirer 123 acquires the second information; for example, the movement information acquirer 123 may perform the processing for acquiring the second information concurrently with the processing for estimating the first movement information performed by the movement information estimator 122.

In this embodiment, misalignment determination is performed based on information obtained when the vehicle 7 is traveling straight in the front-rear direction. Accordingly, the movement distance in the left-right direction acquired by the movement information acquirer 123 equals zero. The movement information acquirer 123 calculates the movement distance in the front-rear direction based on the image taking time interval between the two taken images for the derivation of optical flows and the speed of the vehicle 7 during that interval that is obtained by the vehicle speed sensor 41.

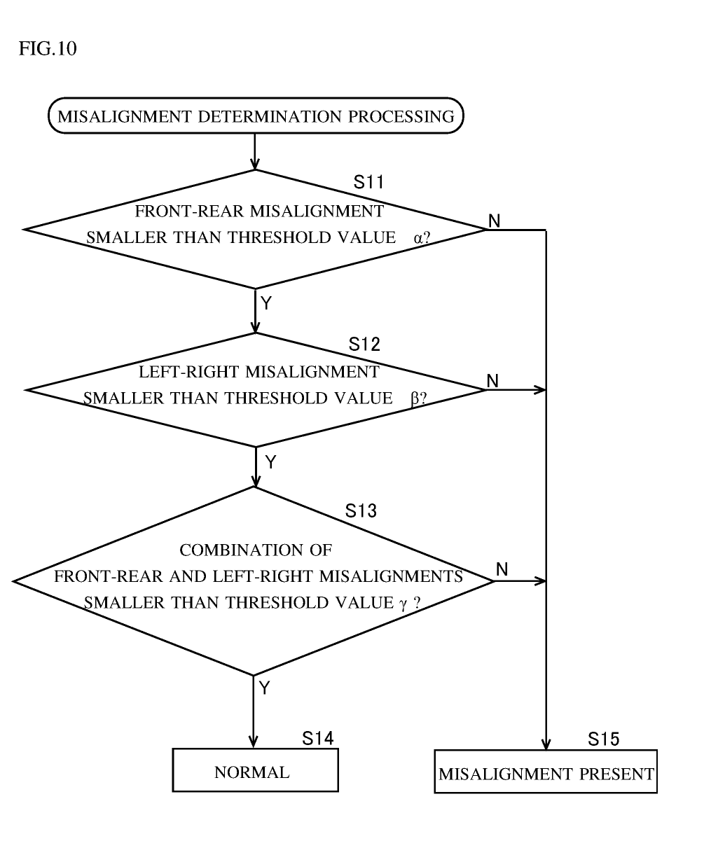

FIG. 10 is a flow chart showing an example of the camera misalignment determination processing performed by the abnormality determiner 124. First, for the movement distance of the vehicle 7 in the front-rear direction, the abnormality determiner 124 checks whether or not the difference between the estimated value calculated by the movement information estimator 122 and the acquired value acquired by the movement information acquirer 123 is smaller than a threshold value a (step S11). If the difference between the two values is equal to or larger than the threshold value a (No in Step S11), the abnormality determiner 124 determines that the front camera 21 is installed in an abnormal state and is misaligned (step S15). On the other hand, if the difference between the two values is smaller than the threshold value a (Yes in Step S11), the abnormality determiner 124 determines that no abnormality is detected from the movement distance of the vehicle 7 in the front-rear direction.

If no abnormality is detected based on the movement distance of the vehicle 7 in the front-rear direction (Yes in step S11), then the abnormality determiner 124, for the movement distance of the vehicle 7 in the left-right direction, checks whether or not the difference between the estimated value calculated by the estimator 122 and the acquired value acquired by the movement information acquirer 123 is smaller than a threshold value f3 (step S12). If the difference between the two values is equal to or larger than the threshold value β (No in step S12), the abnormality determiner 124 determines that the front camera 21 is installed in an abnormal state and is misaligned (step S15). On the other hand, if the difference between the two values is smaller than the threshold value β (Yes in step S12), the abnormality determiner 124 determines that no abnormality is detected based on the movement distance in the left-right direction.

When no abnormality is detected based on the movement distance of the vehicle 7 in the left-right direction, either, then the abnormality determiner 124, for particular values obtained based on the movement distances in the front-rear and left-right directions, checks whether or not the difference between the particular value obtained from the first movement information and the particular value obtained from the second movement information is smaller than a threshold value γ (step S13). In this embodiment, a particular value is a value of the square root of the sum of the value obtained by squaring the movement distance of the vehicle 7 in the front-rear direction and the value obtained by squaring the movement distance of the vehicle 7 in the left-right direction. This, however, is merely an example; a particular value may instead be, for example, the sum of the value obtained by squaring the movement distance of the vehicle 7 in the front-rear direction and the value obtained by squaring the movement distance of the vehicle 7 in the left-right direction.

If the difference between the particular value obtained from the first movement information and the particular value obtained from the second movement information is equal to or larger than the threshold value γ (No in step S13), the abnormality determiner 124 determines that the front camera 21 is installed in an abnormal state and is misaligned (step S15). On the other hand, if the difference between the two values is smaller than the threshold value γ (Yes in step S13), the abnormality determiner 124 determines that the front camera 21 is installed in a normal state (step S14).

In this embodiment, when an abnormality is recognized in any one of the movement distance of the vehicle 7 in the front-rear direction, the movement distance of the vehicle 7 in the left-right direction, and the particular value, it is determined that a camera misalignment is present. With this configuration, it is possible to make it less likely to determine that no camera misalignment is present despite one being present. This, however, is merely an example. For example, a configuration is also possible where, only if an abnormality is recognized in all of the movement distance of the vehicle 7 in the front-rear direction, the movement distance of the vehicle 7 in the left-right direction, and the particular value, it is determined that a camera misalignment is present. It is preferable that the criteria for the determination of a camera misalignment be changeable as necessary via the input section 3.

In this embodiment, for the movement distance of the vehicle 7 in the front-rear direction, the movement distance of the vehicle 7 in the left-right direction, and the particular value, comparison is performed by turns; instead, their comparison may be performed concurrently. In a configuration where, for the movement distance of the vehicle 7 in the front-rear direction, the movement distance of the vehicle 7 in the left-right direction, and the particular value, comparison is performed by turns, there is no particular restriction on the order; the order may be different from that shown in FIG. 10. In this embodiment, misalignment determination is performed based on the movement distance of the vehicle 7 in the front-rear direction, the movement distance of the vehicle 7 in the left-right direction, and the particular value, but this is merely an illustrative example. Instead, for example, misalignment determination may be performed based on any one or two of the movement distance of the vehicle 7 in the front-rear direction, the movement distance of the vehicle 7 in the left-right direction, and the particular value.

In this embodiment, misalignment determination is performed each time the first movement information is obtained by the movement information estimator 122, but this also is merely an illustrative example. Instead, a configuration is possible where camera misalignment determination is performed after the processing for estimating the first movement information is performed by the movement information estimator 122 a plurality of times. For example, at the time point when the estimation processing for estimating the first movement information has been performed a predetermined number of times by the movement information estimator 122, the abnormality determiner 124 may perform misalignment determination by use of a cumulative value, which is obtained by accumulating the first movement information (movement distances) acquired through the estimation processing performed the predetermined number of times. Here, what is compared with the cumulative value of the first movement information is a cumulative value of the second movement information obtained as the target of comparison with the first movement information acquired through the estimation processing performed the predetermined number of times.

In this embodiment, when the abnormality determiner 124 only once determines that a camera misalignment has occurred, the determination that a camera misalignment has occurred is taken as definitive, and thereby a camera misalignment is detected. This, however, is not meant as any limitation. Instead, when the abnormality determiner 124 determines that a camera misalignment has occurred, re-determination may be performed at least once so that, when it is once again determined, as a result of the re-determination, that a camera misalignment has occurred, the determination that a camera misalignment has occurred is taken as definitive.

It is preferable that, when a camera misalignment is detected, the abnormality detection device 1 perform processing for alerting the driver of the vehicle 7 or the like to the detection of the camera misalignment. It is preferable that the abnormality detection device 1 perform processing for notifying the occurrence of a camera misalignment to a driving assisting device that assists driving by using information from the vehicle-mounted cameras 21 to 24. In this embodiment, where the four vehicle-mounted cameras 21 to 24 are provided, it is preferable that such alerting and notifying processing be performed when a camera misalignment has occurred in any one of the four vehicle-mounted cameras 21 to 24.

<2-2. Exceptional Processing in Abnormality Detection Device>

Normally, the abnormality detection device 1 performs camera misalignment detection processing according to flow chart shown in FIG. 3 referred to above. In this embodiment, however, the abnormality detection device 1 does not perform the normal processing but performs exceptional processing in a particular case. Hereinafter, this exceptional processing will be described. There is a case where the exceptional processing is performed in the processing for detecting misalignments of the vehicle-mounted cameras 21 to 24. However, the same exceptional processing is performed on each of the vehicle-mounted cameras 21 to 24, and thus, here, too, for avoidance of overlapping description, the exclusion processing will be described with respect to the front camera 21 as a representative.

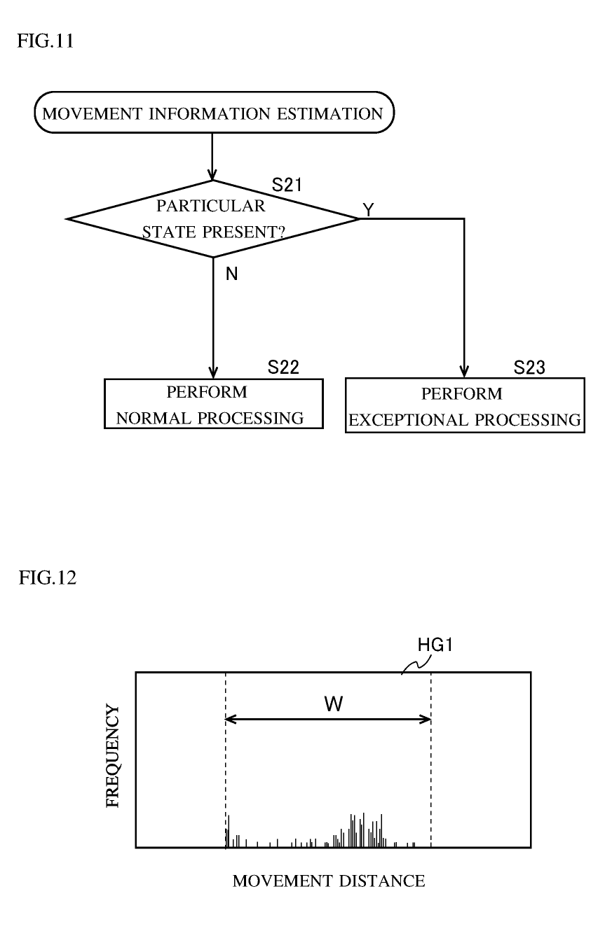

FIG. 11 is a flow chart showing a procedure for determining whether or not to perform the exceptional processing. As shown in FIG. 11, in this embodiment, the abnormality detection device 1 makes a determination on whether or not to have the exceptional processing performed by the movement information estimator 122 as part of the processing for estimating the first movement information.

Before definitizing the first movement information, the movement information estimator 122 checks whether or not a particular state is present (step S21). Particular states are states that degrade the accuracy of the estimation of the first movement information. It is preferable that the particular states include at least one of the following states: a state where the number of feature points FP extracted from the predetermined region PR (ROI) is smaller than a predetermined number; and a state where an index indicating the degree of variations in optical flows of feature points FP exceeds a predetermined variation threshold value. When whichever of these states is present, it is highly likely that the accuracy of the estimation of the first movement information is degraded; accordingly, by performing the exceptional processing when whichever of these states is present, it is possible to enhance the reliability of the processing for detecting camera misalignments.

When it is impossible to obtain a sufficient number of feature points FP, it is also impossible to obtain a sufficient number of optical flows to be used for the estimation of the first movement information. When a small number of optical flows are used in the estimation, an erroneous optical flow included in the optical flows has a large influence on an estimated value. Thus, when the number of optical flows used in the estimation is small, the estimation accuracy is degraded (deteriorates). With this in mind, in this embodiment, the state where the number of feature points FP extracted from the predetermined region PR is smaller than the predetermined number is included in “the particular states”. The predetermined number may be appropriately set, for example, through an experiment, a simulation, etc. Examples of the case where a sufficient number of feature points cannot be obtained include a case where the road surface RS is a concrete surface, which is smoother than an asphalt surface. Here, whether or not the number of feature points FP is smaller than the predetermined number may be determined at a time point when feature points FP are extracted by the feature point extractor 120.

When the degree of variations in optical flows is high, the estimation of the first movement information is performed with a large number of erroneous optical flows included, and this degrades the accuracy of the estimation of the first movement information. With this in mind, in this embodiment, the state where the index indicating the degree of variations in optical flows exceeds the predetermined variation threshold value is included in “the particular states”.

The degree of variations in optical flows can be judged by using, for example, histograms HG1 and HG2 generated based on a plurality of optical flows. In this embodiment, the histograms HG1 and HG2 are generated based on a plurality of second optical flows derived by the flow deriver 121 as described above. That is, in this embodiment, the degree of variations in optical flows is determined by use of second optical flows OF2. This, however, is merely an illustrative example, and the degree of variations in optical flows may be determined by use of first optical flows OF1.

FIG. 12 is a diagram for illustrating the degree of variations in optical flows. FIG. 12 shows a first histogram HG1 as an example. An increase of the degree of variations in optical flows causes, for example, an increase of the distribution width W of the movement distance in the histogram HG1. Accordingly, for example, the distribution width W can be used as an index indicating the degree of variations in optical flows. In this case, the predetermined variation threshold value can be a predetermined distribution width. The predetermined distribution width can be appropriately set, for example, through an experiment, a simulation, etc.

However, the index indicating the degree of variations in optical flows may instead be any of various indices other than the distribution width W. For example, a width between movement distance classes exceeding a predetermined frequency may be used as the index indicating the degree of variations in optical flows. As the index indicating the degree of variations in optical flows, there may be used any of a wide variety of indices indicating a state where a histogram generated based on optical flows deviates from a normal distribution.

The particular states may include, in addition to at least one of the above-described two states, or, instead of the above-described two states, for example, a state determined based on the degree of skewness, kurtosis, etc. of a histogram generated by use of a plurality of optical flows. The degree of skewness is an index that indicates how asymmetric the distribution is, and a state where the absolute value of the degree of skewness exceeds a predetermined threshold value may be a particular state. The degree of kurtosis is an index that indicates the peakedness of the distribution as compared with the normal distribution, and a state where the absolute value of the degree of kurtosis exceeds a predetermined threshold value may be a particular state.

With reference back to FIG. 11, if no particular state is present (No in step S21), it is judged that no such state is present as degrades accuracy of the estimation of the first movement information, and thus the movement information estimator 122 determines to perform the normal processing (step S22). That is, the movement information estimator 122 performs the estimation of the first movement information based on the histograms HG1 and HG2 generated based on second optical flows OF2. The abnormality determiner 124 performs misalignment determination based on the first movement information estimated by the movement information estimator 122 and the second movement information acquired by the movement information acquirer 123.

On the other hand, if a particular state is present (Yes in step S21), it is judged that such a state is present as degrades the accuracy of the estimation of the first movement information, and thus the movement information estimator 122 determines to perform not the normal processing but the exceptional processing (step S23). With this configuration, it is possible to reduce determinations made based on the first movement information estimated with poor accuracy.

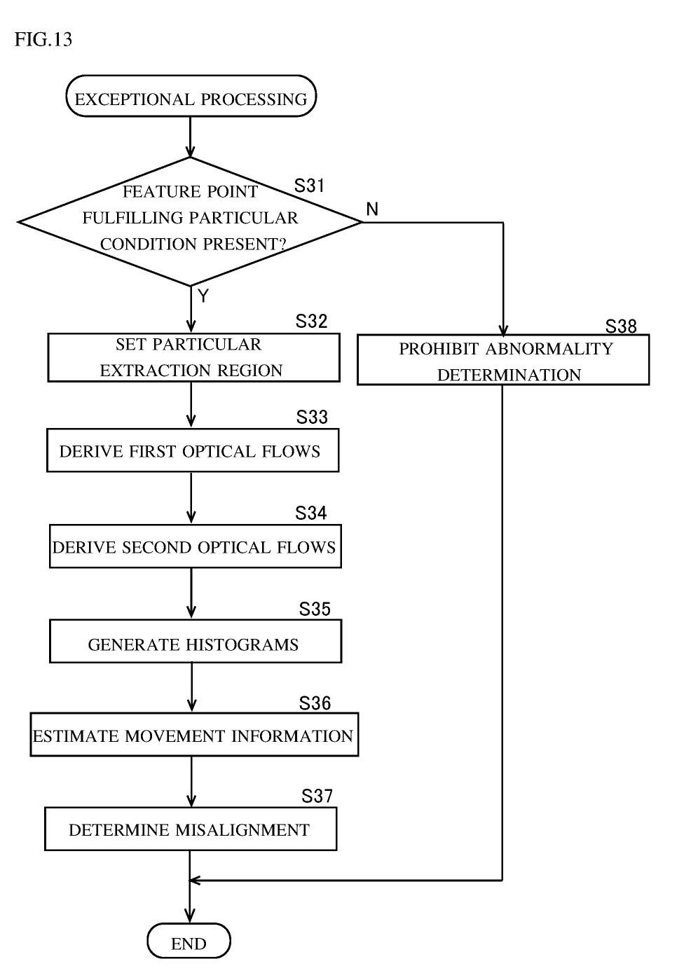

FIG. 13 is a flow chart showing a procedure of the exceptional processing. When the movement information estimator 122 determines to perform the exceptional processing, the controller 12 checks whether or not such a feature point FP is present as fulfills a particular condition (step S31). This checking may be performed by the movement information estimator 122, or, may be performed, for example, by the feature point extractor 120 or the abnormality determiner 124. There may be further provided a particular condition checker which checks the particular condition. The particular condition is fulfilled when, for example, a feature point that is easy to track can be extracted from an image taken by the camera 21.

In this embodiment, the particular condition includes a condition (a first particular condition) that there are a plurality of feature points forming a high density region where feature points FP are present at a higher density than in the other regions. Whether or not a region is a high density region can be judged, for example, based on a predetermined density threshold value determined through an experiment, a simulation, etc. If a high density region is present where the density of feature points FP is higher than the predetermined density threshold value, the controller 12 judges that such feature points as fulfill the particular condition are present.

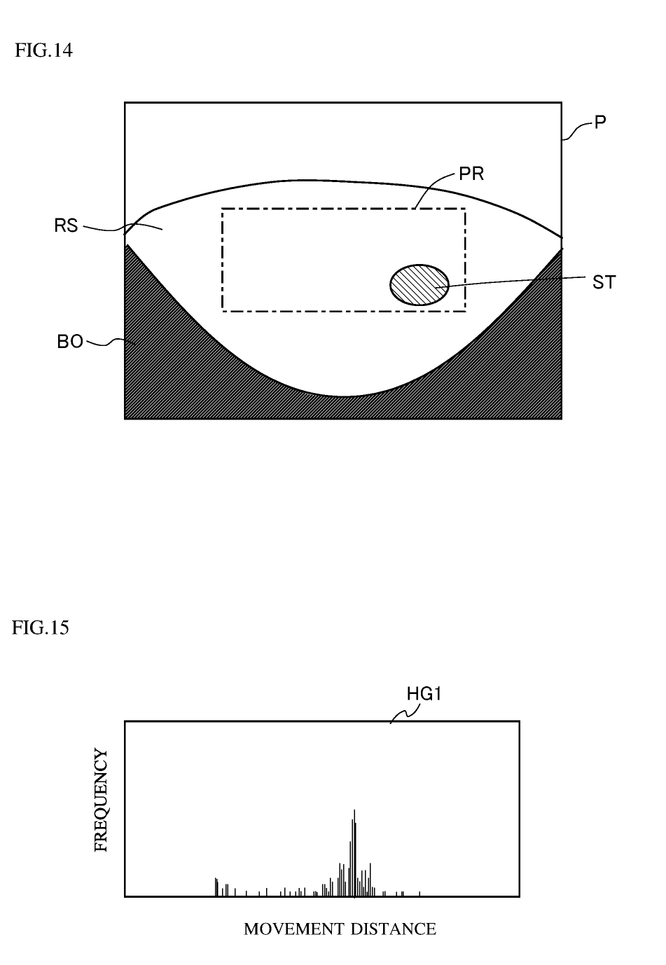

FIG. 14 is a diagram showing an example of a taken image P taken by the camera 21. In the taken image P shown in FIG. 14, a stain ST is present on the road surface RS. In the example shown in FIG. 14, the road surface RS is made of concrete. FIG. 15 is a first histogram HG1 generated based on the taken image P shown in FIG. 14.

When the road surface RS is made of concrete, it is hard to extract feature points FP, and thus the number of feature points FP is small, and it is not easy to track the feature points FP. As a result, the number of optical flows itself becomes small, and variations in optical flow is liable to increase. As shown in FIG. 15, with the stain ST present on the road surface RS that is made of concrete, although the number of optical flows is smaller than on a road surface made of asphalt and the degree of variations in optical flows remains high, a peak appears in the histogram HG1. It can be thought that this is because a large number of such feature points FP as are high in feature degree and easy to track are extracted from the stain ST portion. Here, the case with the stain ST present on the road surface RS is shown as an example. However, with something, such as a pattern provided on the road surface RS, from which feature points FP are extracted at a high density present on the road surface RS, similar results can be obtained as in the case with the stain ST.

Accordingly, it can be expected that, in the case where a high density region in which feature points FP are present at a higher density than the other regions is present, by making use of a plurality of feature points FP that form the high density region, it is possible to perform the estimation of movement information with somewhat high accuracy. Thus, in this embodiment, in the case with a plurality of feature points FP forming a high density region where feature points FP are present at a higher density than in the other regions, if it is judged that the particular condition is fulfilled, the estimation of the first movement information is performed under particular processing.

More specifically, in a case where such feature points FP as fulfill the particular condition are present, a particular extraction region is set instead of the predetermined region PR, and the estimation of the first movement information is performed based on feature points FP extracted from the particular extraction region. This makes it possible to perform the estimation of the first movement information with reduced causes of accuracy degradation, and thus to enhance the reliability of the first movement information obtained as an estimated value.

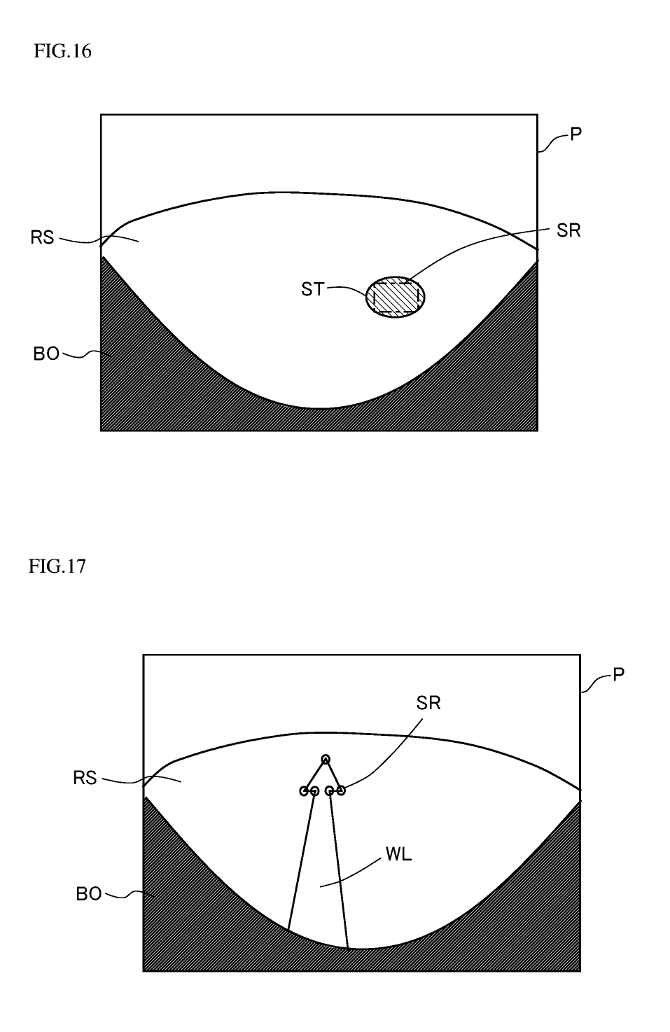

With reference back to FIG. 13, if it is judged that such feature points FP as fulfill the particular condition are present (Yes in step S31), the feature point extractor 120 sets a particular extraction region instead of the predetermined region PR (step S32). The image in which the feature point extraction region is set is an image that has been already acquired, not an image to be acquired anew. FIG. 16 is a diagram for illustrating a particular extraction region SR. FIG. 16 is different from FIG. 14 in that, in the taken image P in FIG. 16, the particular extraction region SR is set instead of the predetermined region PR.

The particular extraction region SR is set in a high density region where feature points FP are present at a higher density than in the other regions. The setting of the particular extraction region SR in the high density region makes it possible to extract a plurality of feature points easy to track, and thus to acquire highly reliable first movement information. In FIG. 16, the stain ST portion is a high density region, and the particular extraction region SR is set inside the stain SR portion. Thus, the particular extraction region SR is set in a high density region. However, since the particular extraction region SR may be set in a high density region where feature points FP are present at a high density, the entire stain ST portion itself may be the particular extraction region SR. Or, for example, the particular extraction region SR may be a region surrounding the stain ST portion.

When the particular extraction region SR is set, feature points FP are extracted therefrom. When the feature points FP are extracted, as shown in FIG. 13, processing similar to the above-described normal processing (see FIG. 3) is performed. More specifically, for each of the feature points FP extracted from the particular extraction region SR, a first optical flow OF1 and a second optical flow OF2 are derived (step S33, step S34). The derivation of the first and second optical flows OF1 and OF2 may be performed again, or a result having been previously found by use of the predetermined region PR may be used.

Based on second optical flows OF2 derived, a first histogram HG1 and a second histogram HG2 are generated (step S35). The estimated value of the movement distance in the front-rear direction is found based on the first histogram HG1, and the estimated value of the movement distance in the left-right direction is found based on the second histogram HG2 (step S36). By comparing the first movement information, which is obtained as these estimated values, with the second movement information, which is acquired based on information obtained from the vehicle speed sensor 41, camera misalignment determination is performed (step S37).

In this embodiment, if it is judged that a particular state, which degrades the accuracy of the estimation of the first movement information, is present, the setting of the particular extraction region SR is performed. More specifically, if a particular state is present, on a condition that such feature points FP as fulfill the particular condition are present, the particular extraction region SR is set instead of the predetermined region PR, which is used in the normal processing. From the particular extraction region SR, such feature points FP as are easy to track can be extracted. This makes it possible to enhance the accuracy of the estimation of the first movement information despite the presence of a particular state, and to quickly make a reliable determination of a camera misalignment.

If it is judged that a particular state is present, and no such feature point FP as fulfills the particular condition is present (No in step S31), the abnormality determiner 124 determines not to perform abnormality determination based on an image taken by the camera in which a particular state has been judged to be present (step S38). This makes it possible to avoid camera abnormality determination performed by use of such first movement information as has been estimated with degraded accuracy. That is, it is possible to reduce occurrence of erroneous detection of camera misalignments.

<3. Modified Example>

The particular condition described above may include a condition (a second particular condition) that, among feature points FP extracted by the feature point extractor 120, there is present a particular feature point at which the cornerness degree, which indicates cornerness, is equal to or higher than a predetermined cornerness degree threshold value. The particular condition may include both the first particular condition (the condition regarding the high density region) and the second particular condition. The particular condition may include only the first particular condition. The particular condition may include only the second particular condition. It is preferable that the particular condition include at least one of the first particular condition and the second particular condition.

FIG. 17 is a diagram for illustrating the cornerness degree. FIG. 17 is an example of taken images P taken by the vehicle-mounted cameras 21 to 24. In the example shown in FIG. 17, a white line WL is arranged on a road surface RS. The white line WL is an arrow, for example. In FIG. 17, what is indicated by each of small circles is a corner at which two edges intersect with each other. At such a corner, the cornerness degree, which indicates the cornerness, is high. The cornerness degree can be found by use of a well-known detection method such as the Harris operator, the KLT(Kanade-Lucas-Tomasi) tracker, or the like.

In this modified example, the cornerness degree is used also as an index for extracting feature points FP. That is, such a point (pixel) at which the cornerness degree is equal to or higher than a first threshold value is extracted as a feature point. A feature point at which the cornerness degree is equal to or higher than a second threshold value (a predetermined cornerness degree threshold value), which is larger than the first threshold value, is detected as a particular feature point. The first threshold value and the second threshold value are appropriately determined through an experiment, a simulation, etc. In the example shown in FIG. 17, the corners indicated by the small circles are detected as particular feature points. Neither the inside of the white line WL nor the edge portions of the white line WL excluding the corners are detected as particular feature points. Particular feature points each have such a high feature degree (cornerness degree) that it is easy to track them. That is, optical flows can be obtained with high accuracy from particular feature points. Particular feature points may be detected, for example, from road surface markings other than white lines, or structures (a hydrant lid, and so forth) provided on the road surface.

In this modified example, when it is judged that a particular state is present, if a particular feature point at which the cornerness degree is equal to or higher than the second threshold value is extracted, a particular extraction region SR is set instead of the predetermined region PR. Then, based on a feature point extracted from the particular extraction region SR, the estimation of the first movement information is performed. In this modified example, the particular extraction region SR is the extraction position where a particular feature point is extracted. Thus, a particular feature point itself is extracted from the particular extraction region SR. According to this modified example, since the estimation of the first movement information can be performed by use of an easily trackable feature point FP, it is possible to acquire highly reliable first movement information.

Here, the number of particular extraction regions SR is the same as the number of particular feature points. The number of particular extraction regions SR may be one, or two or more. In the example shown in FIG. 17, five particular extraction regions SR are set. With more particular extraction regions SR, the first movement information can be estimated with higher accuracy. Thus, the configuration may be such that the particular condition is fulfilled when the number of particular feature points present is equal to or more than a predetermined number that is two or more.

In the case where the particular condition includes both the first particular condition (with a high density region) and the second particular condition (with a particular feature point at which the cornerness degree is high), there is a case where the two particular conditions are both fulfilled. In such a case, the particular extraction region SR may be set in either one of, or in each of, the high density region and the extraction position of the particular feature point. In the case where the particular condition includes both the first particular condition and the second particular condition, when only the first particular condition is fulfilled, the particular extraction region SR is set in the high density region, and when only the second particular condition is fulfilled, the particular extraction region SR is set at the extraction position of the particular feature point.

<4. Points to Note>

The configurations of the embodiments and modified examples specifically described herein are merely illustrative of the present invention. The configurations of the embodiments and modified examples can be modified as necessary without departure from the technical idea of the present invention. Two or more of the embodiments and modified examples can be implemented in any possible combination.

The above description deals with configurations where the data used for the determination of an abnormality in the vehicle-mounted cameras 21 to 24 is collected when the vehicle 7 is traveling straight. This, however, is merely an illustrative example; instead, the data used for the determination of an abnormality in the vehicle-mounted cameras 21 to 24 can be collected when the vehicle 7 is not traveling straight. By use of the speed information obtained from the vehicle speed sensor 41 and the information obtained from the steering angle sensor 42, the actual movement distances of the vehicle 7 in the front-rear and left-right directions can be found accurately; it is thus possible to perform the abnormality determination as described above even when the vehicle 7 is not traveling straight.

What is claimed is:

1. An abnormality detection device that detects an abnormality in a camera mounted on a mobile body, the abnormality detection device comprising:
a feature point extractor configured to extract a feature point from a predetermined region in an image taken by the camera;
a movement information estimator configured to estimate first movement information on the mobile body based on the feature point;
a movement information acquirer configured to acquire second movement information on the mobile body, the second movement information being a target of comparison with the first movement information; and
an abnormality determiner configured to determine an abnormality in the camera based on the first movement information and the second movement information,
wherein,
if such a feature point as fulfills a particular condition is present, a particular extraction region is set instead of the predetermined region, and estimation of the first movement information is performed based on the feature point extracted from the particular extraction region.

2. The abnormality detection device according to claim 1,
wherein
if it is judged that a particular state which degrades accuracy of estimation of the first movement information is present, setting of the particular extraction region is performed.

3. The abnormality detection device according to claim 2,
wherein
the particular state includes at least one of a state where a number of feature points extracted from the predetermined region is smaller than a predetermined number and a state where an index indicating a degree of variations in optical flows of the feature points exceeds a predetermined variation-threshold value.

4. The abnormality detection device according to claim 2,
wherein,
when it is judged that the particular state is present, if no such feature point as fulfills the particular condition is present, the abnormality determiner does not perform abnormality determination based on an image taken by the camera in which the particular state has been determined to be present.

5. The abnormality detection device according to claim 1,
wherein
the particular condition includes a condition that there are a plurality of feature points that form a high density region where the feature points are present at a higher density than in the other regions, and
the particular extraction region is set at the high density region.

6. The abnormality detection device according to claim 1,
wherein
the particular condition includes a condition that, among feature points extracted by the feature point extractor, there is present a particular feature point at which a cornerness degree, which indicates cornerness, is equal to or higher than a predetermined cornerness degree threshold value, and
the particular extraction region is set at an extraction position of the particular feature point.

7. The abnormality detection device according to claim 1,
wherein
the movement information acquirer acquires the second movement information based on information obtained from a sensor other than the camera provided on the mobile body.

8. The abnormality detection device according to claim 1,
wherein
the abnormality is a state where an installation misalignment of the camera is present.

9. An abnormality detection method for detecting an abnormality in a camera mounted on a mobile body, the method comprising:
a feature point extracting step of extracting a feature point from a predetermined region in an image taken by the camera;
a movement information estimating step of estimating first movement information on the mobile body based on the feature point;
a movement information acquiring step of acquiring second movement information on the mobile body, the second movement information being a target of comparison with the first movement information; and
an abnormality determining step of determining an abnormality in the camera based on the first movement information and the second movement information,
wherein
if such a feature point as fulfills a particular condition is present, estimation of the first movement information is performed based on the feature point extracted from a particular extraction region.

10. A movement information estimation device that estimates movement information on a mobile body based on information from a camera mounted on the mobile body, the movement information estimation device comprising:
a feature point extractor configured to extract a feature point from a predetermined region in an image taken by the camera; and
a movement information estimator configured to estimate movement information on the mobile body based on the feature point,
wherein
if such a feature point as fulfills a particular condition is present, estimation of the movement information on the mobile body is performed based on the feature point extracted from a particular extraction region.
